(19) United States
(12) Patent Application Publication
(10) Pub. No.: US 2019/0205861 A1
(43) Pub. Date: Jul. 4, 2019

(54) Customer-directed Digital Reading and Content Sales Platform

(71) Applicant: Marjan Bace, Shelter Island, NY (US)

(72) Inventor: Marjan Bace, Shelter Island, NY (US)

(21) Appl. No.: 15/861,439

(22) Filed: Jan. 3, 2018

(51) Int. Cl. G06Q 20/22; G06F 21/10; G06F 21/31

(52) U.S. Cl. CPC G06Q 20/29; G06Q 2220/12; G06F 21/31; G06F 21/10

(57) ABSTRACT

A system by which digital print content may be purchased and read by way of purchased segments is described. The system includes a platform, which facilitates purchases of content segments via micro-transactions. Unpurchased segments remain obscured by randomly scrambled text until the time of purchase. Consumers are able to search the entirety of the contents of the digital print content for select keywords to determine if the content contains information relevant to the needs of the consumer. Additionally, chapter headings and the table of contents remain unobscured to facilitate a precursory summary of the content available for purchase. Consumers are afforded the option to purchase the entirety of the content outright, or segment-by-segment. If the cost of the total purchased segments approaches the cost of the content as a whole, the entirety of the content is unlocked without need for additional purchases.

### FIELD OF THE PRESENT INVENTION

The present invention relates in general to digital reading and content purchasing systems, and more specifically relates to a system by which digital text content is protected and segmented by paragraph for purchase via a pay-as-you-read platform.

### BACKGROUND OF THE PRESENT INVENTION

The popularity of digital text distribution services such as Amazon™, along with proprietary formats and readers such as the popular Amazon Kindle™, have made e-reading convenient and accessible. Conventionally, users must purchase the entirety of an e-book, online magazine, or other digital content in order to read any content other than specific paragraphs, pages, or chapters selected by the publisher and made available free-of-charge,

Reading platforms such as these limit the consumer first by requiring the customer determine if the work is worthy of purchase based solely on the visible content selected by the Publisher. This limitation is unnecessary and unique to electronic books. Customers physically present within a brick and mortar bookstore are able to read much more of the content prior to purchase.

Secondly, current dominant e-reading platforms limit the usefulness of the material for both customer and Publisher, insofar as it is useful only to customers who have determined that it is worthwhile to purchase the whole work. A customer desiring to read only a small portion of a published work is unable to do so unless that portion is included in the free material made available by the Publisher. Similarly, the Publisher is unable to make non-predetermined selections from the book visible to the customer without making the whole book available.

Thirdly, consumers frequently do not need the entirety of the content for their purposes, which leaves a large portion of the content unneeded and unread. There is presently no way to search through non-purchased digital content to determine if, in fact, the content contains the answers and/or help the consumer is seeking, and no way to purchase only the desired content within a work if the full work is not needed.

These problems are compounded for technical content, as the cost of technical manuals, primary source academic journals, scientific journals, and other professional content is often more expensive than standard fiction and non-fiction works.

Unfortunately, there is presently no digital distribution mechanism consumers may 1) preview content throughout a work in a way that more accurately reflects the content and value of the work, 2) consume small portions of a work without making a purchase, and 3) purchase only the relevant portions of a work.

Thus, there is a need for a new digital content sales and delivery platform that can facilitate exploration of the full content of a digital work while preserving the commercial value of the work for the Publisher and to accept incremental payments for customer-selected portions of the digital content. Such a system would enable consumers to purchase digital content piecemeal, unlocking any number of segments of the content according to their needs. In such a platform, as the consumer continues to purchase segments of the content and the incurred costs approach the retail cost of the content, the publisher might unlock the emainder of the content. Additionally, such a platform preferably redefines the nature of searching and browsing through the content itself prior to purchase, insofar as each customer would independently choose the content to be previewed, rather than the Publisher.

Such a platform might be configured to accept traditional means of purchase for transactions approaching the ordinary price of a published work, and micro-payments are preferably employed for smaller transactions (less than a dollar USD) which are facilitated via pre-paid credits purchased as a block, and used by the consumer to purchase segments of content.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a digital content distribution and purchasing platform that is configured to enable users to browse and purchase segments of digital content ranging in scope from a single paragraph to the entire work.

The system and platform of the present invention facilitates an innovative motivation of digital content consumption. As readers view the digital content, they may be persuaded to purchase the next paragraph, especially if the content is suspenseful, to continue reading the content at a fraction of the cost of purchasing the entirety of the content outright, effectively automating the concept of serial sales within any work.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The present invention will be better understood with reference to the appended drawing sheets, wherein:

FIG. 1 shows a screenshot of the platform of the present invention, detailing the scrambled text available for purchase/unlock.

FIG. 2 depicts a chart detailing a potential purchase scale for segments of content for incremental purchase via micro-transactions.

FIG. 3 exhibits a flow chart detailing the process of use of the present invention as seen from the viewpoint of a consumer.

FIG. 4 depicts a screenshot of the platform of the present invention, detailing the payment/unlock features.

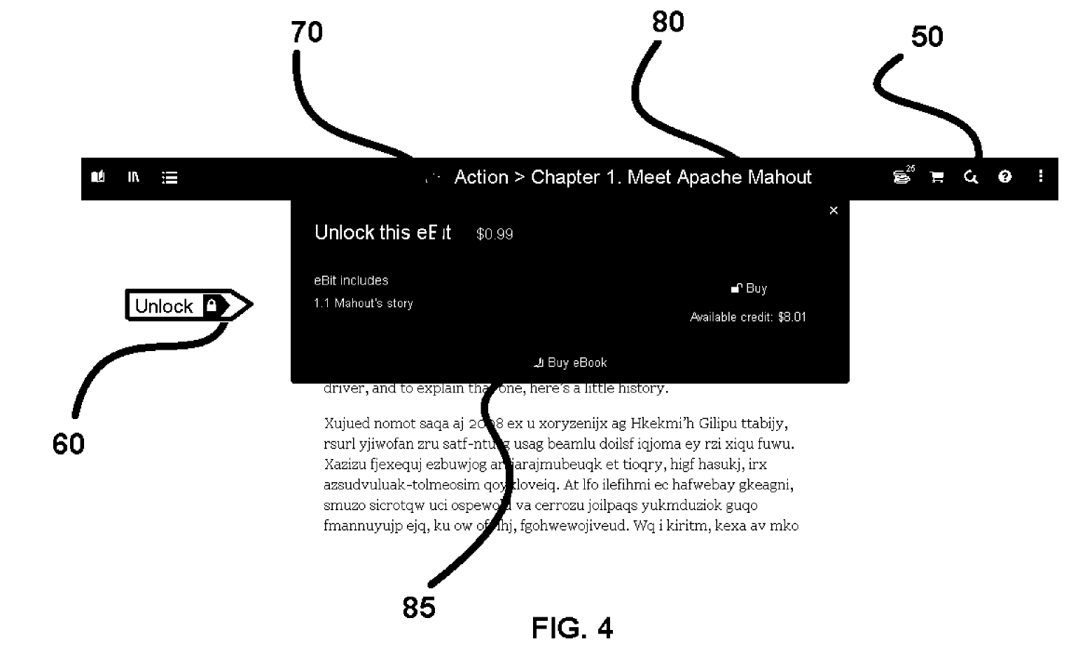

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection.

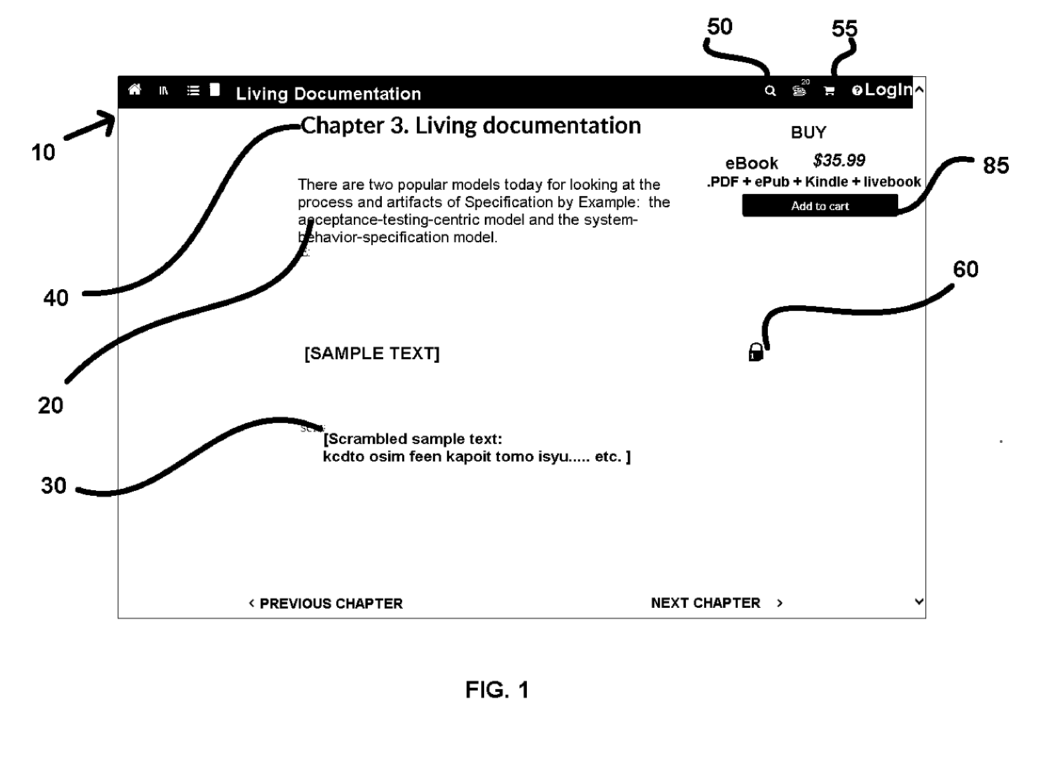

The present invention is a digital content distribution system and platform configured to enable the consumer to purchase digital content in segments via micro-transactions. The preferred embodiment of the present invention employs an online platform (10), as shown in FIG. 1, which both facilitates the purchase and viewing of digital print content. FIG. 1 depicts sample digital print content (20), which is shown as the first few paragraphs or chapter of the content. As with conventional digital content distribution platforms, this sample digital print content (20) is preferably free of charge. Each chapter title is left unobscured.

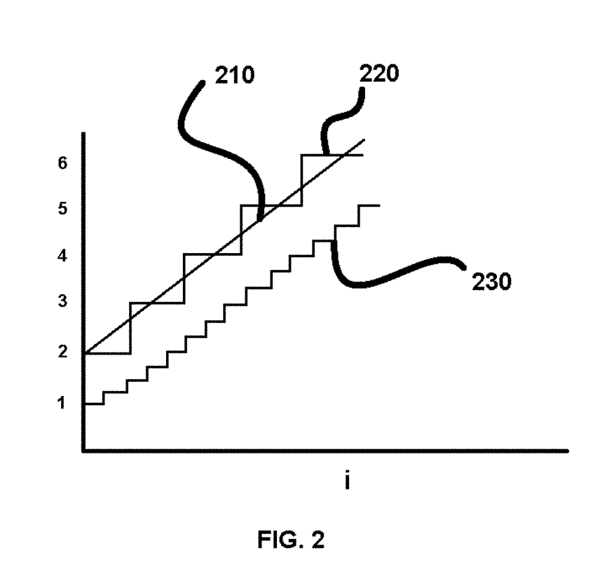

Content other than the sample digital print content (20) and unobscured chapter titles (40) is shown as obscured content (30), which may be purchased by the consumer by credits. Credits are preferably converted from standard currency, such as US dollars, as shown by the formula and chart depicted in FIG. 2. Once unlocked via a micro-transaction by the payment of at least one credit, the obscured content (30) is descrambled, and is thereby converted to purchased content (35). Chapter titles (40) remain unobscured to help the consumer understand the contents of the e-book or other content. Similarly, the table of contents, which primarily depicts the chapter titles (40), also remains unobscured on the platform (10) of the present invention.

Obscured content (30) is in a scrambled state, which employs a proprietary algorithm which requires a data connection to be unscrambled. In order to achieve the scramble of obscured content (30), the algorithm replaces a lower-case letter with a random lower-case letter, and an upper-case letter is replaced with a random upper-case letter. As such, there is not preferably a ‘key’ in a conventional sense that would enable a user to de-scramble the obscured content (30) independent of the platform (10). The original paragraphs of content are housed on the secured server, and may not be accessed by the user until payment to unlock the content is processed. Content is downloaded to the user's device to replace the obscured content (30) on an as-needed, as-purchased basis.

The platform (10) of the present invention is preferably equipped with a search feature (50), which enables the consumer to search for a keyword or terms present within the entirety of the digital print content. In the event that the keyword is found within the content, the found keyword is unobscured within the context of the content. Additionally, the paragraph containing the context of the searched keyword is preferably unobscured free of charge for the consumer. As such, the search feature (50) saves the consumer from purchasing content that does not contain information pertaining to the sought keyword or terms—for free. Paragraphs or segments that contain indexed terms are also preferably left as obscured content (30) for the consumer, with the exception of the searched keyword, which is unscrambled for the user.

When a user desires to purchase a segment of obscured content (30), the consumer clicks on an unlock button (60), which is preferably disposed in the margin of the obscured content (30). It should be noted that the unlock button (60) may be disposed anywhere within the platform (10) in accordance with current window size, device used, browser used, or other factors. Upon hovering a mouse pointer over the unlock button (60), the cost (in credits/tokens) to unlock the segment obscured content (30) is displayed to the user. Upon clicking the unlock button (60), the content is preferably unlocked instantly, and is descrambled. The obscured content (30) is purchased as the unlock button (60) is activated, and requisite tokens and/or funds are withdrawn from the account of the user. It should be noted that alternative input mechanisms aside from a mouse may be employed, such as a touch screen interface.

The buy (or ‘complete purchase’) button is available from the shopping cart page, accessible via the shopping cart button (55) or the add-to-cart button (85), as long as the consumer presently has enough funds in his or her user account. If the consumer fails to have the required funds within his or her account, the consumer is instructed to deposit funds at a minimum of ten USD to continue with the purchase. Alternately, some embodiments of the present invention may employ a ‘two-click buy method’ in which a user clicks the unlock button (60) which then presents the value of the desired section to the user. The user than simply clicks ‘confirm’ to complete the purchase, unlocking the content. After the purchase is complete, the obscured content (30) is descrambled, becoming purchased content (35).

Purchased content (35) may be returned for a refund, and is permanently licensed to the consumer in the preferred embodiment of the present invention if the user keeps the content. Refunds are preferably only issued on a per-case basis by customer support staff. Additionally, a customer may ‘cash out’ their remaining tokens in their account if they do not wish to spend additional funds on the platform of the present invention.

The add-to-cart button (85) is preferably present at the top right of the page, which enables the consumer to purchase the entirety of the e-book or other digital print content outright if desired. A conventional cart button (55) is preferably present within the platform of the present invention to keep track of purchases beyond the scope of micro-transactions, as well as to keep a history of the micro-transaction purchases of the user.

As previously mentioned, the minimum charge to a consumer is preferably ten USD, which is then converted to tokens as the in-platform currency. It is envisioned that content may cost as e as ten cents, however the in-platform token cost may be 25 tokens per segment to unlock. If the cost of the total purchased segments approaches the cost of the content as a whole (the entire e-book), the entirety of the content is unlocked without need for additional purchases.

The purchase cost of each segment is determined in part by the length of the digital print content. As such, the purchase cost per segment is cheaper in longer c-books than it is for shorter e-books. The variable pricing model of the system of the present invention can best be seen in the chart present in FIG. 2. Line (210) depicts the desired price line. Line (220) depicts the price-line in terms of tokens. Line (230) depicts the average list price of content in terms of tokens.

Some embodiments of the present invention preferably employ a pricing formula which assigns a price, in credits, for each paragraph or section of the content. Content, such as a book or technical manual, is priced proportionally to the total amount of sections or paragraphs within the content. Books with a large number of sections, and therefore, long books, have paragraphs which are priced less than that of paragraphs from shorter books. The list price divided by the total number of paragraphs for book ‘i’ is the average list price cost of a single paragraph and it is LP(i)/N(i). This average list price curve will look like the small steps in the following graph in Which the horizontal axis is as shown in FIG. 2 The lowest average list price per paragraph defines the value of one token: T=LP(1)/N(1). In such cases, the value of a token is around one penny. That same book's paragraphs will cost two tokens, as will a number of other books whose LP/N is close to T. Paragraphs in other books will cost 3T, 4T, and so on. FIG. 2 defines the points at which the price steps are taken.

In preferred embodiments of the present invention, a simplified formula is preferably used. The formula employed is as follows:
A token costs 5 cents and unscrambles one paragraph.
Chapter price=1.2×list price/# of chapters−# of free chapters.
Section price=chapter_price/relative_number_of_words

As with the extended formula of alternate embodiments of the present invention, the entire content of an eBook/online content is unlocked if the user unlocks any portion of the book that equals the total value of the list price of the eBook/online content.

In order to scramble or obscure the content to the obscured content (30) state, an encryption algorithm is preferably employed. The algorithm scrambles the letters of the segment itself randomly, rendering the text unntelligible until purchase. As such, a user may not de-scramble the obscured content (30), as it is randomized. Instead, when the user unlocks the obscured content (30), the original digital print content is then unlocked in his/her account, and is accessible from any browser or device after logging in to the platform. As such, when unlocked, the obscured content (30) is replaced with the purchased content (35).

In some embodiments of the present invention, it is envisioned that the first paragraph of each section chapter, code listings, and images are all left unscrambled for the consumer, which helps the consumer to decide if the content (or segments of the content) is applicable to their needs, and worthy of purchase.

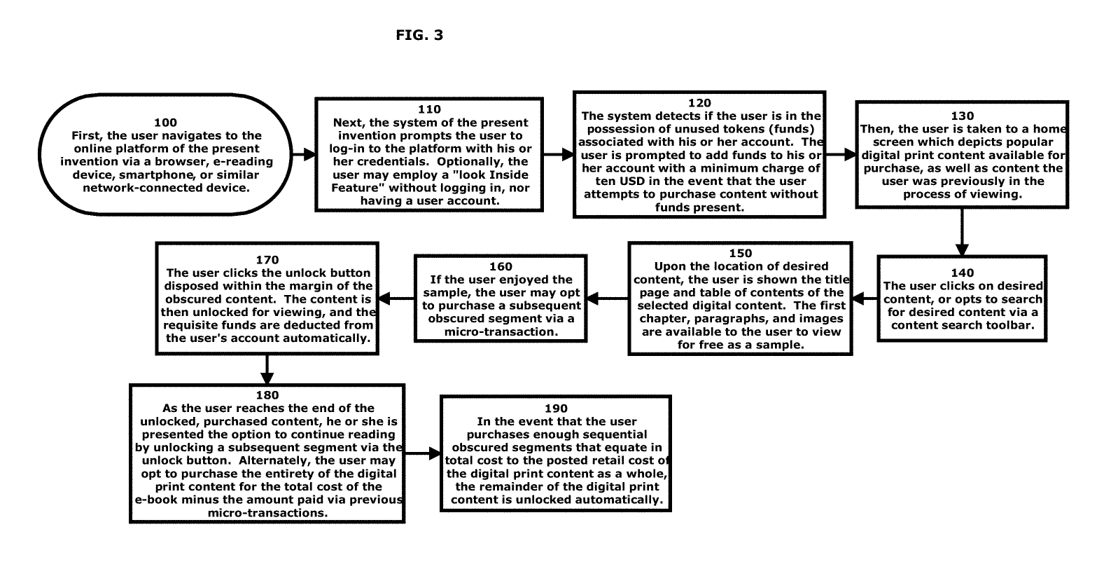

The process of use by a consumer/user of the system oft he present invention, as shown in FIG. 3, is preferably as follows:

1. First, the user navigates to the online platform of the present invention via a browser, e-reading device, smartphone, or similar network-connected device. (100)

2. Next, the system of the present invention prompts the user to log-in to the platform with his or her credentials. Optionally, the user may employ a “Look Inside Feature” without logging in, nor having a user account. (110) In the event that the user does not yet have credentials, including a username and password, the user is prompted to create an account to purchase content.

3. The system detects if the user is in the possession of unused tokens (funds) associated with his or her account. The user is prompted to add funds to his or her account with a minimum charge of ten USD in the event that the user attempts to purchase content without funds present. (120)

4. Then, the user is taken o a home screen which depicts popular digital print content available for purchase, as well as content the user was previously in the process of viewing. (130)

5. The user clicks on desired content, or opts to search for desired content via a content search toolbar. (140)

6. Upon locating desired content, the user is shown the title page and table of contents of the selected digital content. The first chapter, paragraphs, and images are available to the user to view for free as a sample. (150)

7. If the user enjoyed the sample, the user may opt to purchase a subsequent obscured segment via a micro-transaction (160) If the user did not find what he or she was looking for within the sample, or did not wish to continue reading for any reason, the user is free to navigate to another e-book or other content.

8. The user clicks the unlock button disposed within the margin of the obscured content. The content is then unlocked for viewing, and the requisite funds (in tokens) are deducted from the user's account automatically. (170)

9. As the user reaches the end of the unlocked, purchased content, he or she is presented the option to continue reading by unlocking a subsequent segment via the unlock button. Alternately, the user may opt to purchase the entirety of the digital print content for the total cost of the e-book minus the amount paid via previous micro-transactions. (180)

10. In the event that the user purchases enough sequential obscured segments that equate in total cost to the posted retail cost of the digital print content as a whole, the remainder of the digital print content is unlocked automatically. (190) Content may be purchased in any order, and need not be sequential portions of the content.

It should be noted that the entirety of the content may be purchased by the user at any time. Any funds put forth to purchase segments by the user are deducted from the overall credit cost of the purchase price of the content as a whole.

It should be understood that a user may employ a ‘guest’ account in order to view free content, including the first chapter and chapter titles, as well as to employ the ‘look inside feature’ without the need for a formal user account.

Additionally, it should be understood that a user may purchase more than one segment of digital print content by unlocking entire chapters or pages of content. To do so, the user preferably clicks the unlock button (60) adjacent to the chapter headings disposed within the table of contents of the digital print content.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A digital print content commerce and viewing system for use by a user to view and purchase digital print content comprising:
a server computer, said server computer hosting digital print content;
at least one client computer, said at least one client computer in communication with said server;
at least one human interface device, said at least one human interface device disposed in communication with said at least one client computer;
wherein said server computer divides the digital print content into purchasable segments;
a token cost, said token cost associated with each purchasable segment of said purchasable segments of the digital print content;
wherein said token cost is the same for each purchasable segment;
wherein said token cost is displayed adjacent to each purchasable segment; and
wherein said purchasable segments are scrambled until purchased by the user via manipulation by said at least one human interface device.

2. The system of claim 1, wherein said at least one client computer is a mobile device.

3. The system of claim 1, wherein said at least one client computer is a tablet computer.

4. The system of claim 1, wherein said human interface device is a mouse.

5. The system of claim 1, wherein said human interface device is a touchscreen.

6. The system of claim 1, wherein the digital print content is equipped with chapter titles; and
wherein said chapter titles are unscrambled without purchase.

7. The system of claim 1, further comprising:
a first paragraph of the digital print content, said first paragraph is unscrambled.

8. The system of claim 1, further comprising:
a user account, said user account attributed to the user;
wherein said user account is password protected; and
wherein said user account is linked to financial information.

9. The system of claim 3, wherein the digital print content is equipped with chapter titles; and
wherein said chapter titles are unscrambled without purchase.

10. The system of claim 3, further comprising:
a first paragraph of the digital print content, said first paragraph is unscrambled.

11. The system of claim 3, further comprising:
a user account, said user account attributed to the user;
wherein said user account is password protected; and
wherein said user account is linked to financial information.

12. A method of purchasing and viewing digital print content on a mobile device by a user comprising:
downloading a digital content application to the mobile device of the user;
installing the digital content application to the mobile device of the user;
launching the digital content application on the mobile device of the user;
creating a user account via the digital content application;
wherein said creating a user account via the digital content application includes the creation of a username and a password, referenced as credentials;
logging in to a secured server computer with the credentials via the digital content application;
the secured server computer presenting digital print content to the user via the digital content application in a scrambled format as scrambled content segments;
the secured server computer presenting chapter titles of the digital print content in an unscrambled format to the mobile device via the digital content application;
the digital content application presenting the user the option to unscramble the scrambled content for a fee;
the digital content application interfacing with a financial institution associated with the user for payment of the fee;
the digital content application providing an unlock content button adjacent to the scrambled content segments; and
manipulating the unlock content button with a human interface device, charging the user the fee, and unlocking the selected scrambled content to become unlocked content.

13. The method of claim 12, further comprising:
the user reading the unlocked content;
the user opting to purchase more scrambled content segments;
the user manipulating the unlock content button, adjacent to the desired scrambled content segments, with the human interface device; and
the server computer deducting the requisite fee from the user account of the user.
